(19) United States
(12) Patent Application Publication
(10) Pub. No.: US 2023/0037083 A1
(43) Pub. Date: Feb. 2, 2023

(54) SYSTEM FOR FLEXIBLE DATA ROUTING BASED ON INTERACTIONS OF A RESOURCE INSTRUMENT AND REMOTE SYSTEM

(71) Applicant: BANK OF AMERICA CORPORATION, Charlotte, NC (US)

(72) Inventors: Charles Russell Kendall, Snoqualmie, WA (US); Richard C. Clow, II, Morristown, NJ (US); Mark Monaco, New York, NY (US)

(73) Assignee: BANK OF AMERICA CORPORATION, Charlotte, NC (US)

(21) Appl. No.: 17/387,081

(22) Filed: Jul. 28, 2021

(51) Int. Cl. G06Q 20/02; G06F 16/23; G06Q 20/40; G06Q 40/02

(52) U.S. Cl. CPC G06Q 20/02; G06F 16/2379; G06Q 20/405; G06Q 40/02; G06Q 20/4014

(57) ABSTRACT

Embodiments of the invention are directed to systems, methods, and computer program products for flexible data routing of transactions using a single resource instrument. As such, the system results in increased flexibility of resource transfers by enabling a user to establish a virtual link between an account and a resource instrument not originally associated with said account. The user may then complete a transaction using a preferred account, despite the preferred resource instrument being not accepted or otherwise ineffective at a particular merchant. Furthermore, the system may activate data routing requests in real-time, allowing a user to rapidly complete a transaction from any location.

### BACKGROUND

Merchants or other third-party systems that collect payments often accept a limited number of transaction types, such as particular credit card networks or the like. Typically, when a merchant does not accept a preferred resource instrument of a user, the user must use a secondary resource instrument associated with a secondary entity or source retainer to complete resource transfers. Currently, if a user wants to complete a resource transfer using a preferred source retainer associated with a preferred resource instrument which is not accepted by a merchant, the user has no option for completing said transfer. As such, a need exists for a user to be able to associate a single resource instrument with multiple source retainers associated other resource instruments, in order to flexibly complete a resource transfer based on a particular merchant's or third party system's requirements.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the invention relate to systems, methods, and computer program products for flexible data routing based on a resource instrument, the invention including: receiving, from a managing entity, a request for data routing, where the request includes information identifying a requester, information identifying a resource instrument, information identifying an account associated with the requester and not associated with the resource instrument, and information indicating a set of conditions under which to activate the request; storing the request in a database; receiving, from the managing entity, transaction data of a transaction between a user and a third party system, where the transaction data includes at least information identifying the user, information identifying the resource instrument used, and a timestamp; identifying, based on the information identifying the user, a stored request in the database where the requester matches the user identified in the transaction data and the request is activated during the time at which the transaction occurred; determining whether the resource instrument identified in the stored request matches the resource instrument identified in the transaction data; transmitting, based on determining that the resource instrument identified in the stored request matches the resource instrument identified in the transaction data, the transaction data to a primary institution system associated with the account identified in the stored request; and receiving, from the primary institution system, a confirmation of transaction authorization and completion.

In some embodiments, the invention further includes transmitting, to the managing entity and based on the request for data routing being stored in the database, a notification.

In some embodiments, the request for data routing from the managing entity is generated by the managing entity in response to receiving a user request from a user device via a network.

In some embodiments, the set of conditions includes at least a time during which the request is activated.

In some embodiments, the set of conditions includes instructions to activate the request based on information associated with the third party system.

In some embodiments, the request for data routing further includes information indicating a secondary account, wherein the secondary account is associated with both the requester and the resource instrument identified in the request.

In some embodiments, the invention further includes transmitting, based on determining that the resource instrument identified in the stored request matches the resource instrument identified in the transaction data, a message including the transaction data to a secondary institution system associated with the secondary account identified in the stored request.

In some embodiments, the message transmitted to the secondary institution system further includes information identifying the primary institution system and instructions to forward the transaction data to the primary institution system.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 illustrates an operating environment for the data routing system, in accordance with one embodiment of the present disclosure;

FIG. 2 is a block diagram illustrating the data routing system;

FIG. 3 is a block diagram illustrating a flexible data routing request associated with the data routing system; and

FIG. 4 is a flow diagram illustrating a process using the data routing system, in accordance with one embodiment of the present disclosure.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

“Entity” or “managing entity” as used herein may refer to any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a user to establish a source retainer or an account with the entity. A “source retainer” or an “account” may be the relationship that the user has with the entity. Examples of source retainers or accounts include a deposit account, such as a transactional account (e.g., a banking account), a savings account, an investment account, a money market account, a time deposit, a demand deposit, a pre-paid account, a credit account, or the like. The account is associated with and/or maintained by the entity. In other embodiments, an entity may not be a financial institution. In still other embodiments, the entity may be the merchant itself.

“Entity system” or “managing entity system” as used herein may refer to the computing systems, devices, software, applications, communications hardware, and/or other resources used by the entity to perform the functions as described herein. Accordingly, the entity system may comprise desktop computers, laptop computers, servers, Internet-of-Things (“IoT”) devices, networked terminals, mobile smartphones, smart devices (e.g., smart watches), network connections, and/or other types of computing systems or devices and/or peripherals along with their associated applications.

“User” as used herein may refer to an individual associated with an entity. As such, in some embodiments, the user may be an individual having past relationships, current relationships or potential future relationships with an entity. In some instances, a “user” is an individual who has a relationship with the entity, such as a customer or a prospective customer. In some instances described herein, the user is an individual who seeks to utilize, operate, or perform one or more activities associated with a computer terminal, typically based on successful validation of the user's authentication credentials. In other embodiments, a user may be a system or an entity performing one or more tasks described herein.

Accordingly, as used herein the term “user device” or “mobile device” may refer to mobile phones, personal computing devices, tablet computers, wearable devices, and/or any portable electronic device capable of receiving and/or storing data therein.

“Transaction” or “resource transfer” as used herein may refer to any communication between a user and a third party merchant or individual to transfer funds for purchasing or selling of a product. A transaction may refer to a purchase of goods or services, a return of goods or services, a payment transaction, a credit transaction, or other interaction involving a user's account. In the context of a financial institution, a transaction may refer to one or more of: a sale of goods and/or services, initiating an automated teller machine (ATM) or online banking session, an account balance inquiry, a rewards transfer, an account money transfer or withdrawal, opening a bank application on a user's computer or mobile device, a user accessing their e-wallet, or any other interaction involving the user and/or the user's device that is detectable by the financial institution. A transaction may include one or more of the following: renting, selling, and/or leasing goods and/or services (e.g., groceries, stamps, tickets, DVDs, vending machine items, and the like); making payments to creditors (e.g., paying monthly bills; paying federal, state, and/or local taxes; and the like); sending remittances; loading money onto stored value cards (SVCs) and/or prepaid cards; donating to charities; and/or the like. “Resource instrument” or “instrument” as defined herein may refer to any instrument that can be utilized to facilitate the transfer of resources (e.g., credit card, debit card, gift card, loyalty card, check, or the like).

The system allows for increased flexibility of resource transfers by enabling a user to establish a virtual link between an account and a resource instrument not originally associated with said account. In some embodiments, the user is able to establish the virtual link from any location in real time. A user may not be aware that a primary payment method is not accepted by a third party merchant until they attempt to complete a transaction at the merchant location. This system disclosed herein allows the user to rapidly generate a link between a preferred resource instrument and a secondary payment method or payment network. The user may then complete the transaction using a method accepted by the third party merchant. There are multiple reasons why a user may choose to use one preferred resource instrument for a transaction, such as that account having an adequate balance, desire to obtain rewards offers, wanting to use credit rather than debit, not wanting to carry multiple resource instruments, etc. The proposed invention benefits a user by maintaining the primary choice of resource instrument for a transaction while eliminating the difficulties caused by a merchant offering limited payment method options.

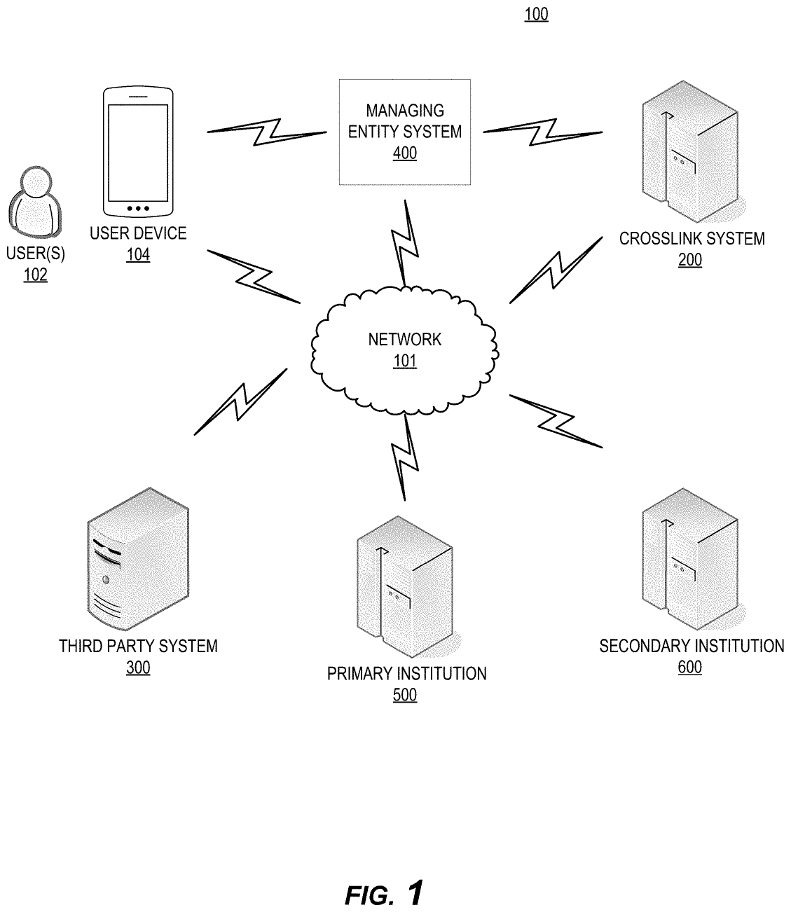

FIG. 1 illustrates an operating environment 100 for the flexible data routing system, in accordance with one embodiment of the present disclosure. As illustrated, the system environment 100 may comprise a user device 104 in operative communication with one or more third party systems 300 via a network 101. The system environment also includes a user 102, a managing entity system 400, a data routing system 200, a primary institution 500, a secondary institution 600, and/or other systems/devices not illustrated herein and connected via a network 101. As such, the user device 104 is configured such that the user 102 may request flexible data routing from the managing entity system 400 by establishing operative communication channels between the user device 104, the managing entity system 400, and/or the crosslinking system 200 via a wireless network 101.

Typically, the data routing system 200 is in operative communication with the managing entity system 400, the primary institution 500, and the secondary institution 600 via the network 101, which may be the internet, an intranet, and/or the like. In FIG. 1, the network 101 may include a local area network (LAN), a wide area network (WAN), a global area network (GAN), and/or near field communication (NFC) network. The network 101 may provide for wireline, wireless, or a combination of wireline and wireless communication between devices in the network. In some embodiments, the network 101 includes the Internet. In some embodiments, the network 101 may include a wireless telephone network. Furthermore, the network 101 may comprise wireless communication networks to establish wireless communication channels such as a contactless communication channel and a near field communication (NFC) channel (for example, in the instances where communication channels are established between the user device 104 and the managing entity system 400). In this regard, the wireless communication channel may further comprise near field communication (NFC), communication via radio waves, communication through the internet, communication via electromagnetic waves and the like.

The user device 104 may comprise a mobile communication device, such as a cellular telecommunications device (i.e., a smart phone or mobile phone), a computing device such as a laptop computer, a personal digital assistant (PDA), a mobile internet accessing device, or other mobile device including, but not limited to portable digital assistants (PDAs), pagers, mobile televisions, gaming devices, laptop computers, cameras, video recorders, audio/video player, radio, GPS devices, any combination of the aforementioned, or the like.

The managing entity system 400 may comprise a communication module and memory not illustrated, and may be configured to establish operative communication channels with a third party system 300 and a user device 104 via a network 101. The managing entity may comprise a user data repository which stores user account data. This data may be used by the managing entity to facilitate network-based transfers between the user device and third party system and may be used to identify resource instruments associated with various user accounts. In some embodiments, the managing entity system is in operative communication with the data routing system 200 via a private communication channel. The private communication channel may be via a network 101 or the data routing system 200 may be fully integrated within the managing entity system 400.

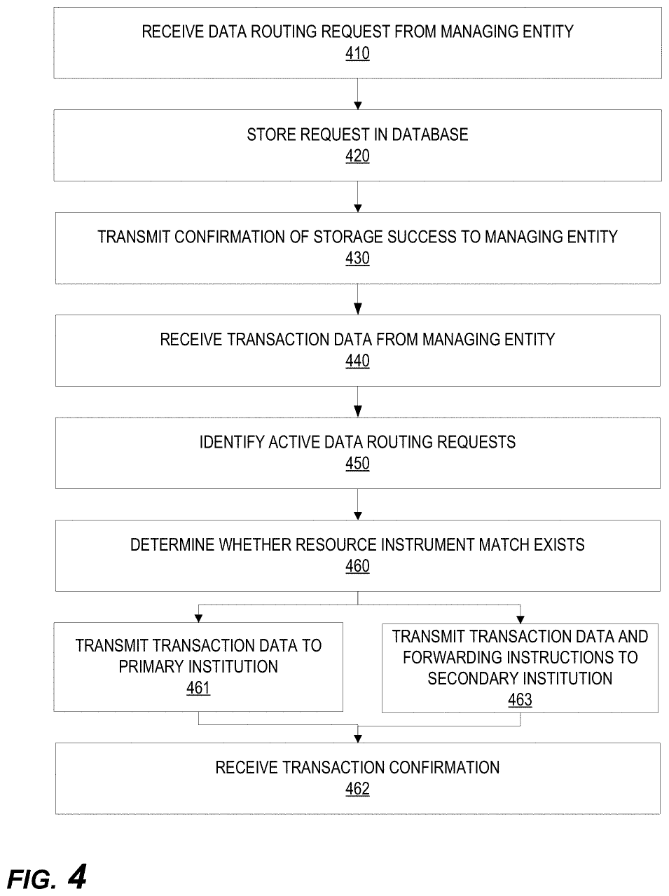

As will be discussed in greater detail in FIG. 4, the managing entity system 400 may communicate with the data routing system 200 in order to complete a flexible data routing request from a user 102. In some embodiments, the managing entity may utilize the features and functions of the data routing system to identify active data routing requests and subsequently route transactions to the appropriate entity for authorization and completion.

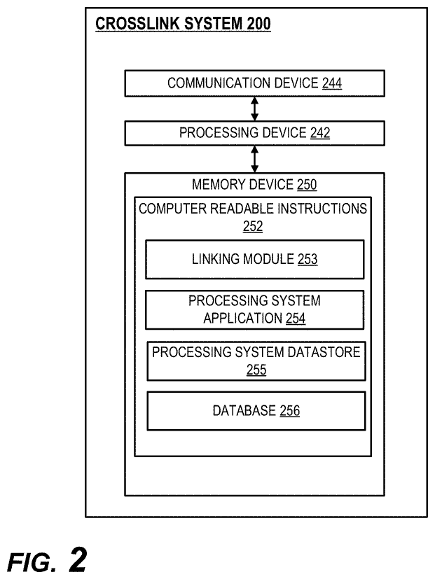

FIG. 2 illustrates a block diagram of the data routing system 200 associated with the operating environment 100, in accordance with embodiments of the present invention. As illustrated in FIG. 2, the data routing system 200 may include a communication device 244, a processing device 242, and a memory device 250 having a linking application/module 253, a processing system application 254, a processing system datastore 255, and a database 256 stored therein. As shown, the processing device 242 is operatively connected to and is configured to control and cause the communication device 244, and the memory device 250 to perform one or more functions. In some embodiments, the linking module 253 and/or the processing system application 254 comprises computer readable instructions that when executed by the processing device 242 cause the processing device 242 to perform one or more functions and/or transmit control instructions to the primary institution 500, the secondary institution 600, the managing entity system 400, and/or the communication device 244. It will be understood that the linking module 253 and/or the processing system application 254 may be executable to initiate, perform, complete, and/or facilitate one or more portions of any embodiments described and/or contemplated herein. The linking module 253 may comprise executable instructions associated with management of flexible data routing requests and routing of associated transactions and may be embodied within the processing system application 254 in some instances. The data routing system 200 may be owned by, operated by and/or affiliated with the same managing entity that owns or operates the managing entity system 400. In some embodiments, the data routing system 200 is fully integrated within the managing entity system 400.

The communication device 244 may generally include a modem, server, transceiver, and/or other devices for communicating with other devices on the network 101. The network communication device 244 may be a communication interface having one or more communication devices configured to communicate with one or more other devices on the network 101, such as the managing entity system 400, the primary institution 500, the secondary institution 600, other processing systems, data systems, etc.

Additionally, referring to the data routing system 200 illustrated in FIG. 2, the processing device 242 may generally refer to a device or combination of devices having circuitry used for implementing the communication and/or logic functions of the crosslinking system 200. For example, the processing device 242 may include a control unit, a digital signal processor device, a microprocessor device, and various analog-to-digital converters, digital-to-analog converters, and other support circuits and/or combinations of the foregoing. Control and signal processing functions of the system 200 may be allocated between these processing devices according to their respective capabilities. The computer processing device or processing device 242 may further include functionality to operate one or more software programs based on computer program instruction code or computer-executable program code 252 thereof, which may be stored in a memory device 250, such as the processing system application 254 and the linking module 253. As the phrase is used herein, a processing device may be “configured to” perform a certain function in a variety of ways, including, for example, by having one or more general-purpose circuits perform the function by executing particular computer-readable program code or computer-readable code portions embodied in computer-readable medium, and/or by having one or more application-specific circuits perform the function. The processing device 242 may be configured to use the network communication interface of the communication device 244 to transmit and/or receive data and/or commands to and/or from the other devices/systems connected to the network 101.

The memory device 250 within the data routing system 200 may generally refer to a device or combination of devices that store one or more forms of computer-readable media for storing data and/or computer-executable program code/instructions. For example, the memory device 250 may include any computer memory that provides an actual or virtual space to temporarily or permanently store data and/or commands provided to the processing device 242 when it carries out its functions described herein.

It is understood that the servers, systems, and devices described herein illustrate one embodiment of the invention. It is further understood that one or more of the servers, systems, and devices can be combined in other embodiments and still function in the same or similar way as the embodiments described herein.

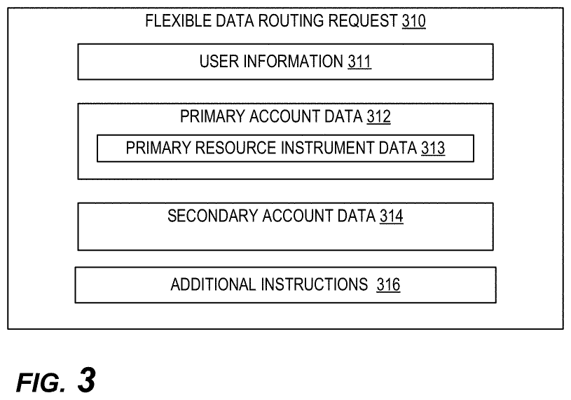

FIG. 3 is a block diagram illustrating a flexible data routing request 310 associated with the data routing system 200, in accordance with one embodiment of the present disclosure. The request 310 comprises user information 311, primary account data 312, primary resource instrument data 313, secondary account(s) data 314, and additional instructions 316. The user information 311 may include any data identifying a user 102 such as a personal identifier, name, customer number, or the like. The primary account data 312 may comprise information identifying an account associated with the user 102, such as account type, account number, and/or the like. The primary resource instrument data 313 may comprise information identifying a physical resource instrument associated with the primary account 312, such as a card or check number, a personal identification number (PIN), and/or the like. The secondary account data 314 may comprise information identifying an account other than the primary account associated with the user 102, such as account type, account number, and/or the like. The additional instructions 316 may comprise a set of conditions for which the request 310 should be activated by the data routing system 200. In some embodiments, the additional instructions 316 may cause the request 310 to be activated immediately. Additionally, or alternatively, the timing information 316 may cause the request 310 to be activated at a particular time, at a particular third party merchant location, only after a third party system has denied the primary account, only for resource transfers above a particular amount and/or of a certain type, and/or any combination thereof. In some embodiments, the additional instructions 316 may cause the request 310 to be deactivated a particular future time or under a specified set of conditions.

FIG. 4 is a high-level process flow diagram illustrating a process using the data routing system, in accordance with one embodiment of the present disclosure. The process begins at block 410, where the system receives a flexible data routing request 310 from the managing entity system 400. In some embodiments, the managing entity system may transmit a flexible data routing request to the data routing system in response to an initial request from a user 102. The user 102 may make an initial request via a user device 104 by sending a call, text, email, instant message, and/or the like to the managing entity system 400. The process continues in block 420, where the system stores the information 311, 312, 313, 314, and 316 in the database 256. The system then transmits a notification 430 indicating data routing success to the managing entity system 400 via the communication device 244.

The process may then continue to block 440, wherein, after the user 102 initiates a transaction with a third party system 300, the system receives transaction data from the managing entity system 400. The transaction data may include any information gathered from the managing entity system 400 which is required to authorize and complete the transaction, such as information identifying the user 102, a resource instrument used, a transaction amount, information identifying the third party system, and/or the like. The process may then continue to block 450, where the data routing system compares the transaction data to the database 256 to identify any data routing requests 310 which are both associated with the user 102 and which are currently activated based on the additional instructions 316. The system may then compare the resource instrument identified in the transaction data to the primary resource instrument data 313 to determine if a match exists 460. If a match exists, in some embodiments, the process may continue to block 461, where the system transmits the transaction data to the primary institution 500 associated with the primary account 312 of identified data routing request 310 for transaction authorization and completion. After completion of the transaction by the primary institution 500, the system 200 may receive a notification 462 from the primary institution indicating transaction success.

Additionally, or alternatively, after determining whether a resource instrument match exists 460, the process may continue to block 463, wherein the system 200 transmits a message to the secondary institution 600 associated with the secondary account 314 of the identified data routing request 310. The message may include the transaction data, data identifying the primary account 312 of the identified data routing request 310, and instructions for the secondary institution 600 to forward the transaction data to the primary institution 500 for transaction authorization and completion. After completion of the transaction by the primary institution 500, the system 200 may receive a notification 462 from the primary institution 500 or secondary institution 600 indicating transaction success.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EEPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions or executable portions embodied therein.

It will also be understood that one or more computer-executable program code portions or instruction code for carrying out or performing the specialized operations of the present invention may be required on the specialized computer include object-oriented, scripted, and/or unscripted programming languages, such as, for example, Java, Perl, Smalltalk, C++, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for flexible data routing based on a resource instrument, the system comprising:
a memory device with computer-readable program code stored thereon;
a communication device; and
a processing device operatively coupled to the memory device and the communication device, wherein the processing device is configured to execute the computer-readable program code to:
receive, from a managing entity, a request for data routing, wherein the request comprises information identifying a requester, information identifying a resource instrument, information identifying an account associated with the requester and not associated with the resource instrument, and information indicating a set of conditions under which to activate the request;
store the request in a database;
receive, from the managing entity, transaction data of a transaction between a user and a third party system, wherein the transaction data comprises at least information identifying the user, information identifying the resource instrument used, and a timestamp;
identify, based on the information identifying the user, a stored request in the database wherein the requester matches the user identified in the transaction data and the request is activated during the time at which the transaction occurred;
determine whether the resource instrument identified in the stored request matches the resource instrument identified in the transaction data;
transmit, based on determining that the resource instrument identified in the stored request matches the resource instrument identified in the transaction data, the transaction data to a primary institution system associated with the account identified in the stored request; and
receive, from the primary institution system, a confirmation of transaction authorization and completion.

2. The system of claim 1, wherein the processing device is further configured to execute the computer-readable program code to transmit, to the managing entity and based on the request for data routing being stored in the database, a notification.

3. The system of claim 1, wherein the request for data routing from the managing entity is generated by the managing entity in response to receiving a user request from a user device via a network.

4. The system of claim 1, wherein the set of conditions comprises at least a time during which the request is activated.

5. The system of claim 1, wherein the set of conditions comprises instructions to activate the request based on information associated with the third party system.

6. The system of claim 1, wherein the request for data routing further comprises information indicating a secondary account, wherein the secondary account is associated with both the requester and the resource instrument identified in the request.

7. The system of claim 6, wherein the processing device is further configured to execute the computer-readable program code to transmit, based on determining that the resource instrument identified in the stored request matches the resource instrument identified in the transaction data, a message comprising the transaction data to a secondary institution system associated with the secondary account identified in the stored request.

8. The system of claim 7, wherein the message transmitted to the secondary institution system further comprises information identifying the primary institution system and instructions to forward the transaction data to the primary institution system.

9. A computer program product for flexible data routing based on a resource instrument with at least one non-transitory computer-readable medium having computer-readable program code portions embodied therein, the computer-readable program code portions comprising:
an executable portion configured to receive, from a managing entity, a request for data routing, wherein the request comprises information identifying a requester, information identifying a resource instrument, information identifying an account associated with the requester and not associated with the resource instrument, and information indicating a set of conditions under which to activate the request;
an executable portion configured to store the request in a database;
an executable portion configured to receive, from the managing entity, transaction data of a transaction between a user and a third party system, wherein the transaction data comprises at least information identifying the user, information identifying the resource instrument used, and a timestamp;
an executable portion configured to identify, based on the information identifying the user, a stored request in the database wherein the requester matches the user identified in the transaction data and the request is activated during the time at which the transaction occurred;
an executable portion configured to determine whether the resource instrument identified in the stored request matches the resource instrument identified in the transaction data;
an executable configured to transmit, based on determining that the resource instrument identified in the stored request matches the resource instrument identified in the transaction data, the transaction data to a primary institution system associated with the account identified in the stored request; and
an executable portion configured to receive, from the primary institution system, a confirmation of transaction authorization and completion.

10. The computer program product of claim 9, further comprising an executable portion configured to transmit, to the managing entity and based on the request for data routing being stored in the database, a notification.

11. The computer program product of claim 10, wherein the request for data routing from the managing entity is generated by the managing entity in response to receiving a user request from a user device via a network.

12. The computer program product of claim 9, wherein the set of conditions comprises at least a time during which the request is activated.

13. The computer program product of claim 9, wherein the set of conditions comprises instructions to activate the request based on information associated with the third party system.

14. The computer program product of claim 9, wherein the request for data routing further comprises information indicating a secondary account, wherein the secondary account is associated with both the requester and the resource instrument identified in the request.

15. The computer program product of claim 14, wherein the computer-readable program code portions further comprise an executable portion configured to transmit, based on determining that the resource instrument identified in the stored request matches the resource instrument identified in the transaction data, a message comprising the transaction data to a secondary institution system associated with the secondary account identified in the stored request.

16. The computer program product of claim 15, wherein the message transmitted to the secondary institution system further comprises information identifying the primary institution system and instructions to forward the transaction data to the primary institution system.

17. A computer-implemented method for flexible data routing based on a resource instrument, the method comprising:
providing a computing system comprising a computer processing device and a non-transitory computer readable medium, where the computer readable medium comprises configured computer program instruction code, such that when said instruction code is operated by said computer processing device, said computer processing device performs the following operations:
receiving, from a managing entity, a request for data routing, wherein the request comprises information identifying a requester, information identifying a resource instrument, information identifying an account associated with the requester and not associated with the resource instrument, and information indicating a set of conditions under which to activate the request;
storing the request in a database;
receiving, from the managing entity, transaction data of a transaction between a user and a third party system, wherein the transaction data comprises at least information identifying the user, information identifying the resource instrument used, and a timestamp;
identifying, based on the information identifying the user, a stored request in the database wherein the requester matches the user identified in the transaction data and the request is activated during the time at which the transaction occurred;
determining whether the resource instrument identified in the stored request matches the resource instrument identified in the transaction data;
transmitting, based on determining that the resource instrument identified in the stored request matches the resource instrument identified in the transaction data, the transaction data to a primary institution system associated with the account identified in the stored request; and
receiving, from the primary institution system, a confirmation of transaction authorization and completion.

18. The computer-implemented method of claim 17, wherein the request for the data routing from the managing entity is generated by the managing entity in response to receiving a user request from a user device via a network.

19. The computer-implemented method of claim 18, wherein the set of conditions comprises at least a time during which the request is activated and instructions to activate the request based on information associated with the third party system.

20. The computer-implemented method of claim 17, wherein the request for data routing further comprises information indicating a secondary account, wherein the secondary account is associated with both the requester and the resource instrument identified in the request, and wherein the computer processing device transmits, based on determining that the resource instrument identified in the stored request matches the resource instrument identified in the transaction data, a message to a secondary institution system associated with the secondary account identified in the stored request, wherein the message comprises information identifying the primary institution system and instructions to forward the transaction data to the primary institution system.
